(19) United States
(12) Patent Application Publication
(10) Pub. No.: US 2013/0041665 A1
(43) Pub. Date: Feb. 14, 2013

(54) Electronic Device and Method of Controlling the Same

(71) Applicants: Seokbok Jang, Seoul (KR); Jongse Park, Seoul (KR); Joonyup Lee, Seoul (KR); Jungkyo Choi, Seoul (KR)

(72) Inventors: Seokbok Jang, Seoul (KR); Jongse Park, Seoul (KR); Joonyup Lee, Seoul (KR); Jungkyo Choi, Seoul (KR)

(21) Appl. No.: 13/241,450

(22) Filed: Sep. 23, 2011

Related U.S. Application Data
(63) Continuation of application No. PCT/KR2011/005904, filed on Aug. 11, 2011.

(51) Int. Cl. G10L 15/00; G10L 11/00

(52) U.S. Cl. 704/246; 704/275; 704/E15.001

(57) ABSTRACT

There are disclosed an electronic device and a method of controlling the electronic device. The electronic device according to an aspect of the present invention includes a display unit, a voice input unit, and a control unit configured to output a plurality of contents through the electronic device, receive a voice command through the voice input unit for performing a command, determine which of the plurality of contents correspond to the received voice command, and perform the command on one or more of the plurality of contents that correspond to the received voice command. According to the present invention, multi-tasking performed in an electronic device can be efficiently controlled through a voice command.

### BACKGROUND

1. Field of the Invention

The present invention relates to an electronic device and a method of controlling the same and, more particularly, to an electronic device executing voice recognition and a method of controlling the same.

2. Related Art

Nowadays, Television (TV) employs user interface (UI) elements for interaction with users. Various functions (software) of the TV can be provided in the form of a program through the user interface elements; in this respect, various kinds of UI elements are emerging to improve accessibility to TV.

Accordingly, new technology is needed, which can improve usability of TV by managing various UI elements in an efficient manner.

### SUMMARY

An object of the present invention is to provide an electronic device capable of efficiently controlling multi-tasking for TV, executing multi-tasking according to the execution of a plurality of pieces of content, through a specific voice command in a TV voice recognition system environment, and a method of controlling the electronic device.

An electronic device according to an aspect of the present invention may include a display unit; a voice input unit; and a controller for displaying a plurality of pieces of content in the display unit, receiving a voice command for controlling any one of the plurality of pieces of content through the voice input unit, and controlling content corresponding to the received voice command, from among the plurality of pieces of content.

The electronic device may further include one or more command databases, each corresponding to each of the plurality of pieces of content and controlling each of the plurality of pieces of content. The controller may recognize the received voice command and, when the recognized voice command is matched with any one of the command databases respectively corresponding to the plurality of pieces of content, control content corresponding to the matched command database.

Meanwhile, when the recognized voice command is in common applied to the plurality of pieces of content, the controller may control content, selected according to a predetermined criterion, in response to the recognized voice command.

When the recognized voice command in common applied to the plurality of pieces of content, the controller may provide a user interface for selecting content to be controlled in response to the recognized voice command from the plurality of pieces of content.

When the recognized voice command is in common applied to the plurality of pieces of content, the controller may apply the recognized voice command to each of the plurality of pieces of content by taking the sequence that the plurality of pieces of content executed into consideration.

When the recognized voice command is in common applied to the plurality of pieces of content, the controller may apply the recognized voice command to each of the plurality of pieces of content by taking an arrangement of the plurality of pieces of content disposed in the display unit into consideration.

The electronic device further includes a camera for photographing a speaker. When the recognized voice command is in common applied to the plurality of pieces of content, the controller may control content toward which the speaker is directed in response to the recognized voice command.

The controller may recognize a speaker based on the received voice command, select content to be controlled based on information about the recognized speaker, and control the selected content in response to the voice command.

The information about the recognized speaker may include information about the speaker and content whose control authority belongs to the speaker.

Meanwhile, the plurality of pieces of content displayed in the display unit may have different language characteristics, and the controller may select content related to a language characteristic of the received voice command from the plurality of pieces of content and control the selected content in response to the voice command.

The plurality of pieces of content may include at least one of a broadcasting program, text, an image, video, and an application executable on the electronic device.

An electronic device according to another aspect of the present invention may include a display unit; a voice input unit; and a controller for displaying a plurality of pieces of content in the display unit, receiving a voice command for controlling at least one of the plurality of pieces of content through the voice input unit, selecting at least one piece of content to be controlled in response to the voice command, from the plurality of pieces of content, and controlling the selected content in response to the voice command.

An electronic device according to yet another aspect of the present invention may include a display unit; a voice input unit; and a control unit configured to output a plurality of contents through the electronic device, receive a voice command through the voice input unit for performing a command, determine which of the plurality of contents correspond to the received voice command, and perform the command on one or more of the plurality of contents that correspond to the received voice command.

A method of controlling an electronic device according to yet another aspect of the present invention may include displaying a plurality of pieces of content in a display unit; receiving a voice command for controlling any one of the plurality of pieces of content; selecting one or more pieces of content to be controlled in response to the voice command from the plurality of pieces of content; and controlling the one or more pieces of selected content in response to the voice command.

A method of controlling an electronic device according to yet another aspect of the present invention may include outputting a plurality of contents though the electronic device; receiving a voice command through a voice input unit for performing a command; determining which of the plurality of contents correspond to the voice command; and performing the command on one or more of the plurality of contents that correspond to the received voice command.

### BRIEF DESCRIPTION OF THE DRAWINGS

The present invention will become more fully understood from the detailed description given herein below and the accompanying drawings, which are given by illustration only, and thus are not limitative of the present invention, and wherein:

FIGS. 1 and 2 are diagrams schematically showing a voice recognition system to which methods of controlling an electronic device according to some embodiments of the present invention are applied;

FIG. 3 is a block diagram of an electronic device related to an embodiment of the present invention;

FIG. 4 is a flowchart illustrating a method of controlling the electronic device according to an embodiment of the present invention;

FIG. 5 is a detailed flowchart illustrating a process of selecting content to be controlled in response to a voice command, from a plurality of pieces of content, in the method of controlling the electronic device according to an embodiment of the present invention;

FIGS. 6 to 8 are diagrams showing examples in which content is controlled in response to a voice command in the embodiments of FIGS. 4 and 5;

FIG. 9 is a flowchart illustrating a method of controlling the electronic device according to another embodiment of the present invention;

FIGS. 10 to 14 are diagrams illustrating examples in which content is controlled in response to a voice command in the embodiment of FIG. 9;

FIGS. 15 to 17 show examples of electronic device screens illustrating a method of controlling the electronic device according to another embodiment of the present invention;

FIG. 18 is a flowchart illustrating a method of controlling the electronic device according to yet another embodiment of the present invention;

FIGS. 19 to 22 show examples in which a plurality of pieces of content are controlled in response to a voice command in the embodiment of FIG. 18;

FIG. 23 is an exemplary diagram illustrating a method of controlling the electronic device according to further yet another embodiment of the present invention; and

FIG. 24 is an exemplary diagram illustrating a method of controlling the electronic device according to still yet another embodiment of the present invention.

### DETAILED DESCRIPTION OF THE EMBODIMENTS

Objectives, characteristics, and advantages of the present invention described in detail above will be more clearly understood by the following detailed description. In what follows, preferred embodiments of the present invention will be described in detail with reference to appended drawings. Throughout the document, the same reference number refers to the same element. In addition, if it is determined that specific description about a well-known function or structure related to the present invention unnecessarily brings ambiguity to the understanding of the technical principles of the present invention, the corresponding description will be omitted.

In what follows, the electronic device related to the present invention will be described in more detail with reference to the appended drawings. The suffix of “module” and “unit” associated with a constituting element employed for the description below does not carry a meaning or a role in itself distinguished from the other.

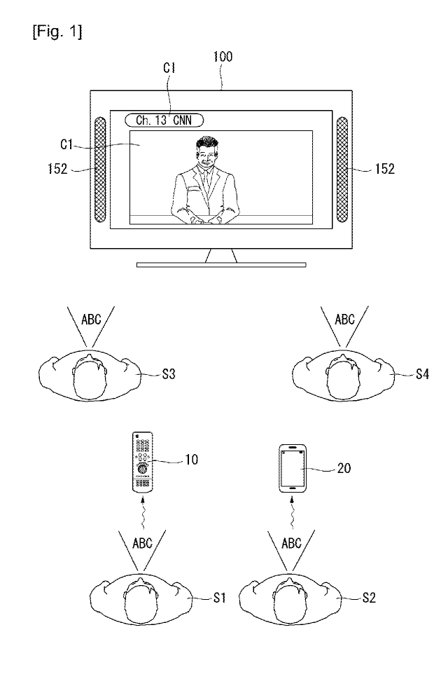

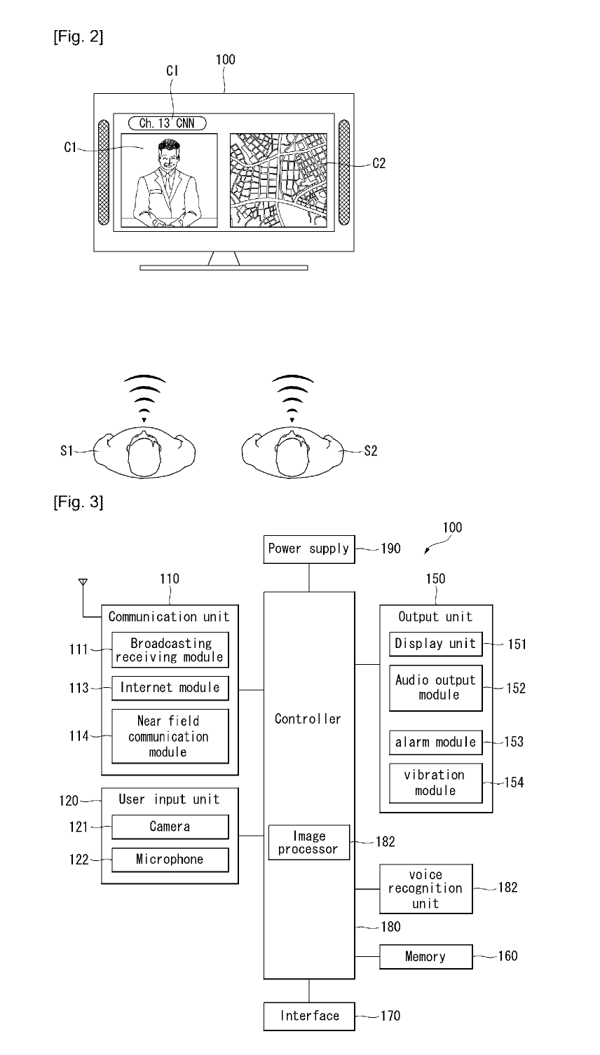

FIGS. 1 and 2 are diagrams schematically showing a voice recognition system to which methods of controlling an electronic device according to some embodiments of the present invention are applied.

The voice recognition system to which the present invention is applied, as shown in FIG. 1, may include an electronic device 100 and voice input means for inputting a voice command to the electronic device 100.

The electronic device 100 can receive a speaker's voice through the voice input means. The voice input means may be a microphone (not shown) within the electronic device 100. For example, the voice input means may include at least one of a remote controller 10 and a mobile terminal 20 outside the electronic device 100. For another example, the voice input means may include an array microphone (not shown) connected to the electronic device 100 in a wired manner or wirelessly. However, the voice input means of the present invention is not limited to the above exemplary voice input means.

The electronic device 100 can recognize voice received through the voice input means and can control all application programs (e.g., a broadcasting program, video, still images, and web browsers) which may be executed on the electronic device 100 through the voice recognition result.

Meanwhile, the electronic device 100 can provide a speaker with feedback related to a process in which the application programs are controlled in response to the inputted voice command. The feedback means may be various. For example, the process in which the application programs are controlled in response to the inputted voice command may be visually fed back through a display unit 151 (refer to FIG. 3) or may be aurally through a speaker, etc. In addition, the process may be fed back through tactile means. Accordingly, a speaker can know that the electronic device 100 is controlled in response to his voice command.

Meanwhile, at least one voice input means for inputting voice to the electronic device 100 may include a microphone (not shown) embedded in an electronic device, the remote controller 10, the mobile terminal 20, and an array microphone (not shown) disposed near the electronic device 100 and the speaker. The voice input means may include at least one microphone phone which can be manipulated by a user and configured to receive a speaker's voice.

Electronic device 100 can be DIV which receives broadcasting signals from a broadcasting station and outputs the signals. Also, the DTV can be equipped with an apparatus capable of connecting to the Internet through TCP/IP (Transmission Control Protocol/Internet Protocol).

The remote control 10 can include a character input button, a direction selection/confirm button, a function control button, and a voice input terminal; the remote control 10 can be equipped with a short-distance communication module which receives voice signals input from the voice input terminal and transmits the received voice signals to the electronic device 100. The communication module refers to a module for short range communications. Bluetooth, RFID (Radio Frequency Identification), infrared data association (IrDA), Ultra wideband (UWB), and Zigbee can be used for short range communications.

The remote control can be a 3D (three dimensional) pointing device. The 3D pointing device can detect three-dimensional motion and transmit information about the 3D motion detected to the DTV 100. The 3D motion can correspond to a command for controlling the DIV 100. The user, by moving the 3D pointing device in space, can transmit a predetermined command to the DIV 100. The 3D pointing device can be equipped with various key buttons. The user can input various commands by using the key buttons.

The Electronic device 100, as in the remote control 10, can include a microphone 122 collecting a speaker S2's voice and transmit voice signals collected through the microphone 122 to the electronic device 100 through a predetermined short range communication module 114.

The electronic device described in this document can include a mobile phone, a smart phone, a laptop computer, a broadcasting terminal (e.g., DTV, IPTV), a PDA (Personal Digital Assistant), a PMP (Portable Multimedia Player), and a navigation terminal. However, the scope of the present invention is not limited to those described above.

Referring to FIG. 2, a plurality of pieces of content (e.g., C1 and C2) can be displayed in the display unit 151 of the electronic device 100.

The plurality of pieces of content can be displayed in the display unit 151 in response to a predetermined user input. The user input can be performed by predetermined input means (e.g., a remote controller or a mobile terminal capable of controlling the electronic device). The input means may include, for example, a predetermined gesture of a user or a user's voice command.

The plurality of pieces of content displayed in the display unit 151 may include broadcasting programs, video, still images, text, and specific applications (e.g., navigation programs). It is assumed that the plurality of pieces of content includes the broadcasting program C1 and the navigation program C2 as shown in FIG. 2, for convenience of description.

When two or more pieces of content are executed in the electronic device 100 as shown in FIG. 2, voice commands spoken by speakers S1 and S2 may control one or more of the two or more pieces of content. That is, the at least one speaker (e.g., S1 and S2) can control at least one of the broadcasting program C1 and the navigation program C2 displayed in the display unit 151 by speaking predetermined voice.

The electronic device 100 may determine which one of or both the first content C1 and the second content C2 will be controlled in response to the voice commands S1 and S2 spoken by the speakers. The electronic device 100 may apply the inputted voice command to content selected according to a predetermined criterion, from the plurality of pieces of content.

The commands to control the plurality of pieces of content may differ according to a kind or an attribute of content.

For example, when the content is the broadcasting program C1, the command to control the broadcasting program C1 may include a command (e.g., a channel number or a specific broadcasting program name, such as “CH 12” or “Infinite Challenge”, or a keyword related to the specific broadcasting program) for switching or searching for a channel, a command (e.g., “Volume Up” or “Off”) for controlling the play of the broadcasting program, and so on.

When the content is the navigation program C2, the command to control the navigation program C2 may include a command capable of executing a function unique to a navigation application, such as “Enlarge Map” and “Search For Shortest Distance”.

Meanwhile, the electronic device 100 may select content to be controlled by the inputted voice command, from among the first content C1 and the second content C2, according to whether the inputted voice command is spoken by which speaker.

For example, it is assumed that the first speaker S1 is a control person which is capable of controlling the broadcasting program C1 and the second speaker S2 is a control person which is capable of controlling the navigation program C2. In this case, the broadcasting program C1 may not be controlled in response to the voice command of the second speaker S2, and the navigation program C2 may not be controlled in response to the voice command of the first speaker S1.

The method of controlling a plurality of pieces of content, being executed on the screen of an electronic device, in response to a voice command spoken by at least one person has been schematically described above with reference to FIGS. 1 and 2. Hereinafter, an electronic device and methods of controlling the electronic device according to embodiments of the present invention are described in more detail below with reference to relevant drawings.

FIG. 3 is a block diagram of the electronic device 100 according to an embodiment of the present invention. As shown, the electronic device 100 includes a communication unit 110, an A/V (Audio/Video) input unit 120, an output unit 150, a memory 160, an interface unit 170, a control unit such as controller 180, and a power supply unit 190, etc. FIG. 3 shows the electronic device as having various components, but implementing all of the illustrated components is not a requirement. Greater or fewer components may alternatively be implemented.

In addition, the communication unit 110 generally includes one or more components allowing radio communication between the electronic device 100 and a communication system or a network in which the electronic device is located. For example, in FIG. 3, the communication unit includes at least one of a broadcast receiving module 111, a wireless Internet module 113, and a short-range communication module 114.

The broadcast receiving module 111 receives broadcast signals and/or broadcast associated information from an external broadcast management server via a broadcast channel. The broadcast channel may include a satellite channel and/or a terrestrial channel. The broadcast management server may be a server that generates and transmits a broadcast signal and/or broadcast associated information or a server that receives a previously generated broadcast signal and/or broadcast associated information and transmits the same to a terminal. The broadcast signal may include a TV broadcast signal, a radio broadcast signal, a data broadcast signal, and the like. Also, the broadcast signal may further include a broadcast signal combined with a TV or radio broadcast signal.

The broadcast associated information may refer to information associated with a broadcast channel, a broadcast program or a broadcast service provider.

The broadcast signal may exist in various forms. For example, the broadcast signal may exist in the form of an electronic program guide (EPG) of the digital multimedia broadcasting (DMB) system, and electronic service guide (ESG) of the digital video broadcast-handheld (DVB-H) system, and the like.

The broadcast receiving module 111 may also be configured to receive signals broadcast by using various types of broadcast systems. In particular, the broadcast receiving module 111 can receive a digital broadcast using a digital broadcast system such as the multimedia broadcasting-terrestrial (DMB-T) system, the digital multimedia broadcasting-satellite (DMB-S) system, the digital video broadcast-handheld (DVB-H) system, the data broadcasting system known as the media forward link only (MediaFLO®), the integrated services digital broadcast-terrestrial (ISDB-T) system, etc.

The broadcast receiving module 111 can also be configured to be suitable for all broadcast systems that provide a broadcast signal as well as the above-mentioned digital broadcast systems. The broadcast signals and/or broadcast-associated information received via the broadcast receiving module 111 may be stored in the memory 160.

The Internet module 113 supports Internet access for the electronic device and may be internally or externally coupled to the electronic device. The wireless Internet access technique implemented may include a WLAN (Wireless LAN) (Wi-Fi), Wibro (Wireless broadband), Wimax (World Interoperability for Microwave Access), HSDPA (High Speed Downlink Packet Access), or the like.

The short-range communication module 114 is a module for supporting short range communications. Some examples of short-range communication technology include Bluetooth™, Radio Frequency IDentification (RFID), Infrared Data Association (IrDA), Ultra-WideBand (UWB), ZigBee™, and the like.

Referring to FIG. 2, the A/V input unit 120 is configured to receive an audio or video signal, and includes a camera 121 and a microphone 122. The camera 121 processes image data of still pictures or video obtained by an image capture device in a video capturing mode or an image capturing mode, and the processed image frames can then be displayed on a display unit 151.

The image frames processed by the camera 121 may be stored in the memory 160 or transmitted via the communication unit 110. Two or more cameras 121 may also be provided according to the configuration of the electronic device.

The microphone 122 can receive sounds via a microphone in a phone call mode, a recording mode, a voice recognition mode, and the like, and can process such sounds into audio data. The microphone 122 may also implement various types of noise canceling (or suppression) algorithms to cancel or suppress noise or interference generated when receiving and transmitting audio signals.

The output unit 150 is configured to provide outputs in a visual, audible, and/or tactile manner. In the example of FIG. 3, the output unit 150 includes the display unit 151, an audio output module 152, an alarm module 153, a vibration module 154, and the like. The display unit 151 displays information processed by the image electronic device 100. For examples, the display unit 151 displays UI or graphic user interface (GUI) related to a displaying image. The display unit 151 displays a captured or/and received image, UI or GUI when the image electronic device 100 is in the video mode or the photographing mode.

The display unit 151 may also include at least one of a Liquid Crystal Display (LCD), a Thin Film Transistor-LCD (TFT-LCD), an Organic Light Emitting Diode (OLED) display, a flexible display, a three-dimensional (3D) display, or the like. Some of these displays may also be configured to be transparent or light-transmissive to allow for viewing of the exterior, which is called transparent displays.

An example transparent display is a TOLED (Transparent Organic Light Emitting Diode) display, or the like. A rear structure of the display unit 151 may be also light-transmissive. Through the configuration, the user can view an object positioned at the rear side of the terminal body through the region occupied by the display unit 151 of the terminal body.

The audio output unit 152 can output audio data received from the communication unit 110 or stored in the memory 160 in an audio signal receiving mode and a broadcasting receiving mode. The audio output unit 152 outputs audio signals related to functions performed in the image electronic device 100. The audio output unit 152 may comprise a receiver, a speaker, a buzzer, etc.

The alarm module 153 generates a signal for informing an event generated from the electronic device 100. The event generated from the electronic device 100 may include a speaker's voice input, a gesture input, a message input, and various control inputs through a remote controller. The alarm module 153 may also generate a signal for informing the generation of an event in other forms (e.g., vibration) other than a video signal or an audio signal. The video signal or the audio signal may also be generated through the display unit 151 or the audio output module 152.

The vibration module 154 can generate particular frequencies inducing a tactile sense due to particular pressure and feedback vibrations having a vibration pattern corresponding to the pattern of a speaker's voice input through a voice input device and transmit the feedback vibrations to the speaker.

The memory 160 can store a program for describing the operation of the controller 180 and also store input and output data temporarily. The memory 160 can store data about various patterns of vibration and sound corresponding to at least one voice pattern input from at least one speaker.

Furthermore, the memory 160 may include an audio model, a recognition dictionary, a translation database, a predetermined language model, and a command database which are necessary for the operation of the present invention.

The recognition dictionary can include at least one form of a word, a clause, a keyword, and an expression of a particular language.

The translation database can include data matching multiple languages to one another. For example, the translation database can include data matching a first language (e.g., Korean) and a second language (e.g., English/Japanese/Chinese) to each other. The second language is a terminology introduced to distinguish it from the first language and can correspond to multiple languages. For example, the translation database can include data matching “ [symbol] ” in Korean to “I'd like to make a reservation” in English.

The command databases form a set of commands capable of controlling the electronic device 100. The command databases may exist in independent spaces according to content be controlled. For example, the command databases may include a channel-related command database for controlling a broadcasting program, a map-related to command database for controlling a navigation program, a game-related command database for controlling a game program.

Each of one or more commands included in each of the channel-related command database, the map-related command database, and the game-related command database has a different subject of control.

For example, in “Channel Switch Command” belonging to the channel-related command database, a broadcasting program is the subject of control. In a “Command for Searching for the Path of the Shortest Distance” belonging to the map-related command database, a navigation program is the subject of control.

Kinds of the command databases are not limited to the above example, and they may exist according to the number of pieces of content which may be executed in the electronic device 100.

Meanwhile, the command databases may include a common command database. The common command database is not a set of commands for controlling a function unique to specific content being executed in the electronic device 100, but a set of commands which can be in common applied to a plurality of pieces of content.

For example, assuming that two pieces of content being executed in the electronic device 100 are game content and a broadcasting program, a voice command spoken in order to raise the volume during play of the game content may be the same as a voice command spoken in order to raise the volume while the broadcasting program is executed.

The memory 160 may also include at least one type of storage medium including a flash memory, a hard disk, a multimedia card micro type, card-type memory (e.g., SD or DX memory), Random Access Memory (RAM), Static Random Access Memory (SRAM), Read-Only Memory (ROM), Electrically Erasable Programmable Read-Only Memory (EEPROM), Programmable Read-Only memory (PROM), magnetic memory, a magnetic disk, and an optical disk. The electronic device 100 may be operated in relation to a web storage device that performs the storage function of the memory 160 over the Internet.

The interface unit 170 serves as an interface with external devices connected with the electronic device 100. For example, the external devices can transmit data to an external device, receive and transmit power to each element of the electronic device 100, or transmit internal data of the electronic device 100 to an external device. For example, the interface unit 170 may include wired or wireless headset ports, external power supply ports, wired or wireless data ports, memory card ports, ports for connecting a device having an identification module, audio input/output (I/O) ports, video I/O ports, earphone ports, or the like.

The controller 180 usually controls the overall operation of the electronic device. For example, the controller 180 carries out control and processing related to image display, voice output, and the like. The controller 10 can further comprise a voice recognition unit 182 carrying out voice recognition upon the voice of at least one speaker and although not shown, a voice synthesis unit (not shown), a sound source detection unit (not shown), and a range measurement unit (not shown) which measures the distance to a sound source.

The voice recognition unit 182 can carry out voice recognition upon voice signals input through the microphone 122 of the electronic device 100 or the remote control 10 and/or the mobile terminal shown in FIG. 1. The voice recognition unit 182 can then obtain at least one recognition candidate corresponding to the recognized voice. For example, the voice recognition unit 182 can recognize the input voice signals by detecting voice activity from the input voice signals, carrying out sound analysis thereof, and recognizing the analysis result as a recognition unit. The voice recognition unit 182 can obtain the at least one recognition candidate corresponding to the voice recognition result with reference to the recognition dictionary and the translation database stored in the memory 160.

The voice synthesis unit (not shown) converts text to voice by using a TTS (Text-To-Speech) engine. TTS technology converts character information or symbols into human speech. TTS technology constructs a pronunciation database for each and every phoneme of a language and generates continuous speech by connecting the phonemes. At this time, by adjusting magnitude, length, and tone of the speech, a natural voice is synthesized; to this end, natural language processing technology can be employed. TTS technology can be easily found in the electronics and telecommunication devices such as CTI, PC, PDA, and mobile devices; and consumer electronics devices such as recorders, toys, and game devices. TTS technology is also widely used for factories to improve productivity or for home automation systems to support much comfortable living. Since ITS technology is one of well-known technologies, further description thereof will not be provided.

A power supply unit 190 provides power required for operating each constituting element by receiving external and internal power controlled by the controller 180.

The power supply unit 190 receives external power or internal power and supplies appropriate power required for operating respective elements and components under the control of the controller 180.

Various embodiments described herein may be implemented in a computer-readable or its similar medium using, for example, software, hardware, or any combination thereof.

For a hardware implementation, the embodiments described herein may be implemented by using at least one of Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, micro-controllers, microprocessors, and electronic units which are designed to perform the functions described herein. In some cases, the embodiments may be implemented by the controller 180 itself.

For a software implementation, the embodiments such as procedures or functions described herein may be implemented by separate software modules. Each software module may perform one or more functions or operations described herein. Software codes can be implemented by a software application written in any suitable programming language. The software codes may be stored in the memory 160 and executed by the controller 180.

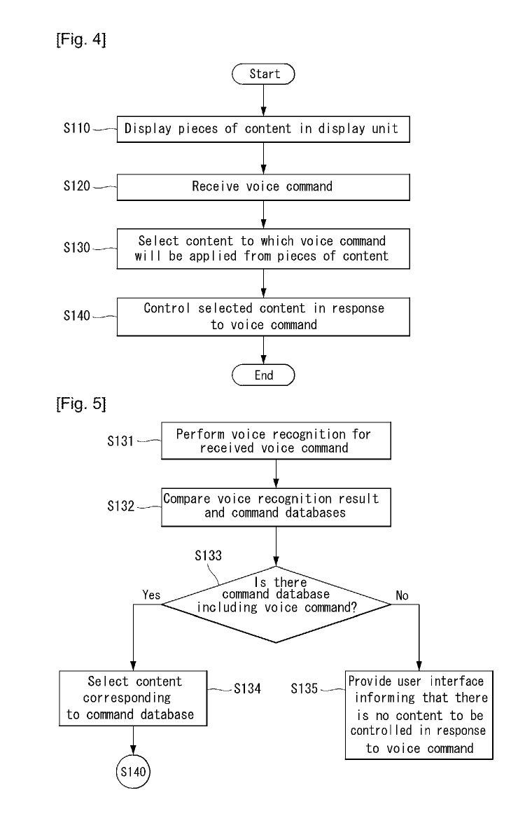

FIG. 4 is a flowchart illustrating a method of controlling the electronic device according to an embodiment of the present invention.

Referring to FIG. 4, the controller 180 of the electronic device 100 may display a plurality of pieces of content in the display unit 151 at step S110.

During the time for which the plurality of pieces of content is displayed and executed in the display unit 151, the controller 180 can receive a voice command from a speaker at step S120.

When the voice command is received, the controller 180 can select content to which the voice command will be applied from the plurality of pieces of content displayed in the display unit 151 at step S130. Criteria for selecting the content that can be controlled in response to the received voice command will be described in more detail with reference to FIG. 5.

When the content to be controlled in response to the voice command is selected, the controller 180 can control the selected content in response to the voice command by applying the voice command to the content at step S140.

The controller 180 can select the content to be controlled in response to the voice command based on a command which will be recognized through the voice command.

FIG. 5 is a detailed flowchart illustrating the process of selecting content to be controlled in response to a voice command, from a plurality of pieces of content, in the method of controlling the electronic device according to an embodiment of the present invention.

Referring to FIG. 5, the controller 180 can perform voice recognition for a received voice command at step S131.

The controller 180 can convert the inputted voice signal into text data. The controller 180 compares the converted text data with command data at step S132. For example, the controller 180 can compare the text data (i.e., the result of the voice recognition) with a plurality of command databases.

If the text data is included in the first database of the plurality of command databases, the controller 180 may select the subject of control of the voice command as content corresponding to the first database at step S134.

When the content to be controlled is selected in response to the voice command, the controller 180 can control the selected content in response to the voice command at step S140.

Meanwhile, if a command database including the voice command does not exist (No, S133), the controller 180 can provide a user interface, informing that there is no content to be controlled in response to the inputted voice command in the plurality of pieces of content which is being displayed and executed in the display unit 151 at step S135.

The command data, as described above, may have different command databases applied according to kinds of content which are being executed through the electronic device 100, such as a channel-related command DB, a map-related command DB, and a game-related command DB.

FIGS. 6 to 8 are diagrams showing examples in which content is controlled in response to a voice command in the embodiments of FIGS. 4 and 5.

The electronic device 100 receives a voice command from a speaker and then needs to switch to a voice input mode so that it can be controlled in response to the voice command.

FIG. 6 shows an example in which a user interface, informing that the electronic device has entered the voice recognition mode, is provided according to an embodiment of the present invention.

Referring to FIG. 6, in the state in which the user interface 11 is being displayed, the electronic device 100 can recognize the voice command of a speaker.

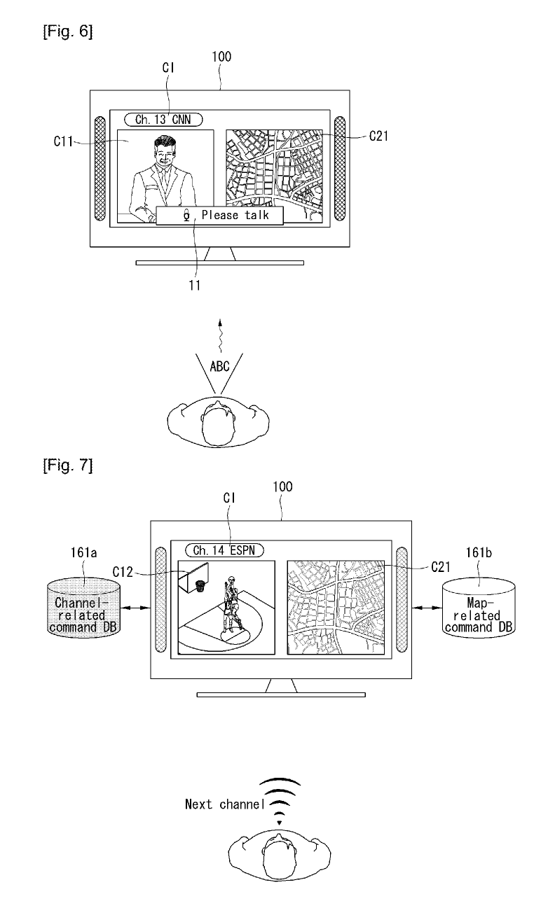

Referring to FIGS. 6 and 7, in the state in which first content C1 (e.g., a broadcasting program) and second content C2 (e.g., a navigation program) are being displayed in the display unit 151, when a speaker speaks a voice command “Next Channel”, the controller 180 can determine whether the voice command is matched with any one of a plurality of command databases.

A news program C11 and a navigation program C21 are being executed in the electronic device 100. A channel-related command DB 161a is associated with the news program C11, and a navigation program C21 is associated with a map-related command DB 161b.

In the above-described example, “Next Channel” is the voice command for changing a channel. The controller 180 can determine that the voice command is matched with the channel-related command DB 161a and apply the voice command “Next Channel” to the first content C1. Accordingly, the controller 180 can change the channel to “CH 14 ESPN” which is a program subsequent to “CH 13 CNN” of FIG. 6.

Meanwhile, when the speaker speaks a voice command “Enlarge Map”, the controller 180 can determine whether the voice command “Enlarge Map” is matched with any one of the command databases. The controller 180 can determine that the inputted voice command is matched with the map-related DE 161b because “Enlarge Map” is a command that can be applied to the navigation-related program and thus apply the voice command “Enlarge Map” to the second content C2. Accordingly, the controller 180 can enlarge the size of the map shown in FIG. 6 as in the example of FIG. 8 and display the enlarged map. In this case, the channel of the first content C1 is not changed. Furthermore, the area where the first content C1 is displayed in the display unit 151 may be reduced according to the enlarged map of the second content C2.

The area where each of a plurality of pieces of content occupied in the display unit 151 may be previously set by a user. Accordingly, the degree that the map is enlarged in response to the voice command “Enlarge Map” may also be previously set by a user. Furthermore, the area where the first content C1 is displayed may be reduced in inverse proportion to the degree that the map is enlarged.

The embodiment in which content is controlled on the basis of a command which is one of criteria for selecting the content controlled in response to a voice command spoken by a speaker, from a plurality of pieces of content being executed in the electronic device 100, has been described above with reference to FIGS. 4 to 8.

The content can be normally controlled based on the command when the voice command spoken by the speaker corresponds to any one of the first content C1 and the second content C2.

If the voice command may be applied to all the plurality of pieces of content, there is another criterion for selecting content to be controlled in response to the voice command.

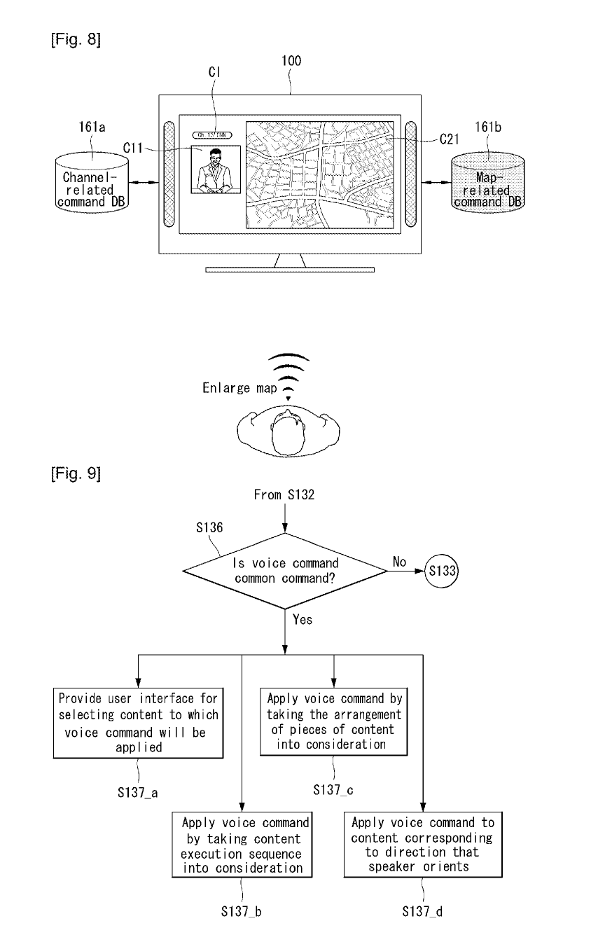

An embodiment in which content is controlled on the basis of a speaker is described below with reference to FIGS. 9 to 14.

FIG. 9 is a flowchart illustrating a method of controlling the electronic device according to another embodiment of the present invention. FIGS. 10 to 14 are diagrams illustrating examples in which content controlled in response to a voice command in the embodiment of FIG. 9. The method can be executed under the control of the controller 180.

Referring to FIGS. 5 and 9, the controller 180 can compare a voice recognition result for a voice command, spoken by a speaker, and the command databases at step S132.

That is, the controller 180 can check whether there is a command database matched with the inputted voice command, from among the plurality of command databases at step S136.

If the number of command databases matched with the inputted voice command is plural, the voice command is a common command.

Referring to FIG. 10, in the state in which first content C1 (e.g., a news program) and second content C2 (e.g., a navigation program) are being displayed in the display unit 151, a speaker may speak a voice command “Turn Off”. The voice command “Turn Off” is not a command for executing a function unique to the first content C1 and a command for executing a function unique to the second content C2. The voice command “Turn Off” is a content execution-related command which may be applied to both the first content and the second content. Accordingly, the controller 180 may determine that the voice command “Turn Off” is matched with a common command DB 161c.

If, as a result of the check at step S136, the voice command is the common command, the controller 180 can select content to which the voice command may be applied, from the plurality of pieces of content displayed in the display unit 151, according to a predetermined criterion.

When the voice command is the common command (Yes, S136), the controller 180 can provide a user interface for selecting content to which the voice command may be applied at step S137_a.

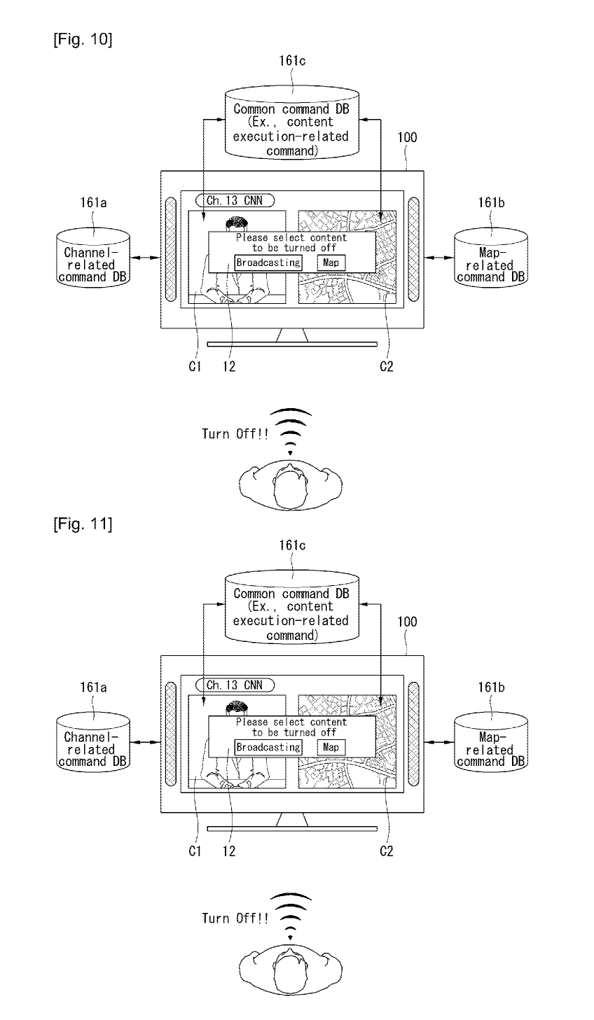

For example, referring to FIG. 11, the controller 180 can display a user interface 12 for enabling the speaker to select content to which the common command will be applied in the display unit 151.

When at least one of the first content C1 and the second content C2 is selected by the speaker, the controller 180 can finish the execution of the selected content.

When the speaker selects both the first content C1 and the second content C2, the controller 180 can finish the execution of both the first content C1 and the second content C2.

If, as a result of the check, the voice command is the common command (Yes, S136), the controller 180 may apply the voice command by taking a content execution sequence into consideration at step S137_b.

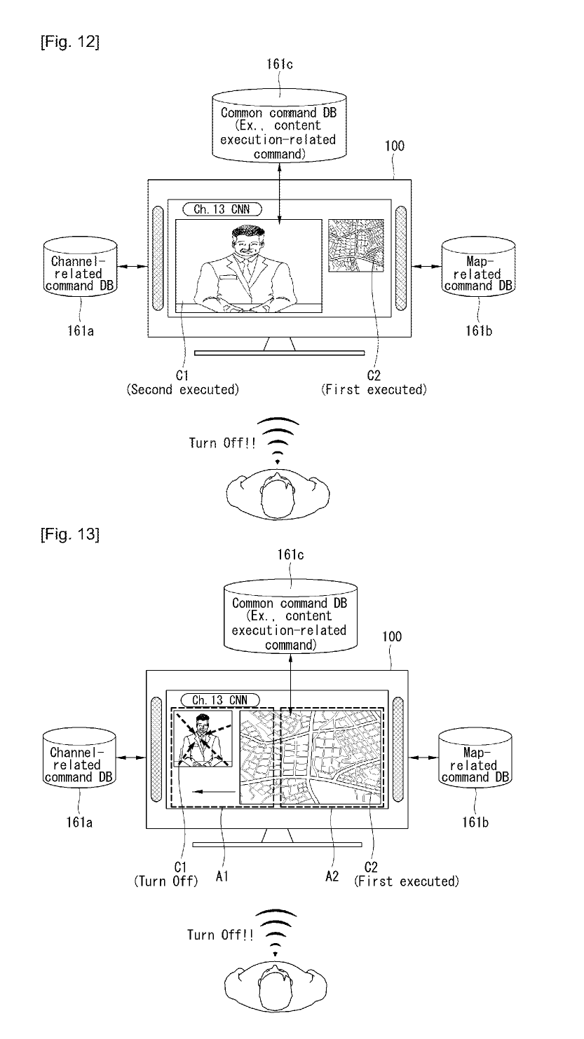

For example, referring to FIG. 12, it is assumed that the navigation program C2 is first executed and the news program C1 is then executed. In this case, the controller 180 may first finish the execution of the navigation program C2 in response to the voice command “Turn Off” spoken by the speaker.

The controller 180 may apply the voice command to each of a plurality of pieces of content according to the content execution sequence because the common command can be applied all the plurality of pieces of content.

For example, after the navigation program C2 first executed is finished, the controller 180 may finish the news program C1, subsequently executed, after a lapse of some time.

In some cases, the controller 180 may first apply the voice command to content having a later content execution sequence.

Furthermore, the sequence that the voice command is applied may be previously defined by a speaker.

If, as a result of the check, the voice command is the common command (Yes, S136), the controller 180 may apply the voice command by taking a plurality of pieces of content arranged in the display unit 151 into consideration at step S137_c.

For example, referring to FIG. 13, a news program C1 may be disposed in a first region A1 on the left side of the display unit 151 and a navigation program C2 may be disposed in a second region A2 on the right side of the display unit 151. In this case, the controller 180 may apply a voice command “Turn Off”, spoken by a speaker, to the news program C1 disposed in the first region A1. Accordingly, the controller 180 may configure the navigation program C2 so that it occupies the entire region of the display unit 151.

The plurality of pieces of content is divided and disposed on the left and right sides of the display unit 151 FIG. 13, but the present invention is not limited thereto. For example, the controller 180 may arrange a plurality of pieces of content in the form of an M×N matrix. The voice command may be applied in order of 1×1, 1×2, . . . , 1×N, 2×1, 2×2, . . . , 2×N, . . . , M×N.

If, as a result of the check, the voice command is the common command (Yes, S136), the controller 180 may determine the direction of the speaker which has be photographed and recognized by the camera 121 (refer to FIG. 3) and select content toward which the speaker is directed, from the plurality of pieces of content displayed in the display unit 151, as content to which the voice command will be applied at step S137_d.

The camera 121 can periodically photograph a speaker. The controller 180 can determine a direction toward which a speaker is directed based on an image of the speaker captured by the camera 121.

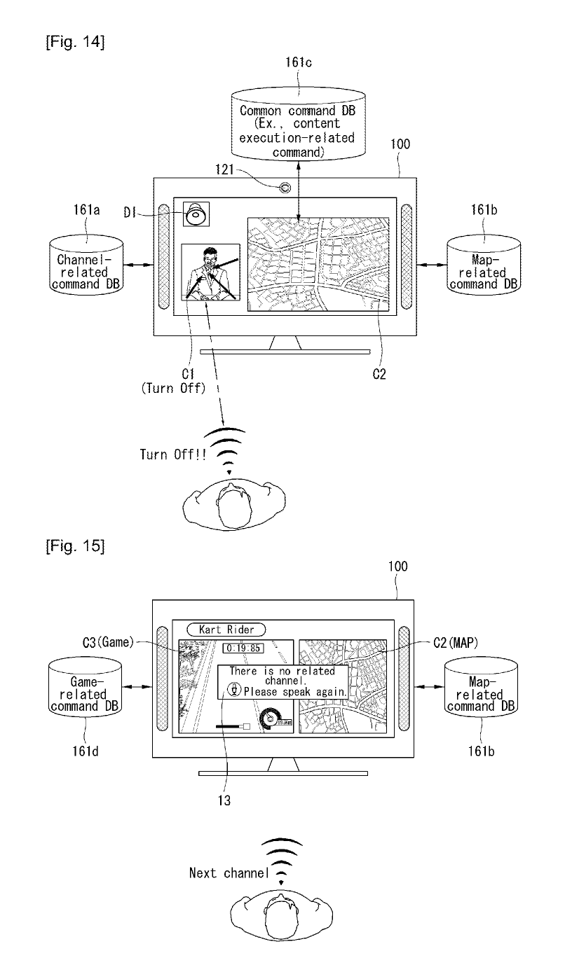

For example, referring to FIG. 14, a speaker may speak a voice command toward a news program C1. The controller 180 may finish the news program C1 by taking a direction toward which the speaker is directed into consideration.

Meanwhile, the controller 180 may display a direction indicator in the display unit 151 so that the speaker can know that his voice command is directed toward which content.

The embodiments in which content to which a voice command spoken by a speaker will be applied is selected when the voice command is a common command have been described above. However, the present invention is not limited to the above examples as the criterion for selecting content to which the voice command will be applied.

Meanwhile, a voice command spoken by a speaker may not be matched with any one of the plurality of command databases stored in the memory 160 of the electronic device 100. This is described below with reference to FIGS. 15 to 17.

FIGS. 15 to 17 show examples of electronic device screens illustrating a method of controlling the electronic device according to another embodiment of the present invention.

FIGS. 15 to 17 show exemplary user interfaces UI displayed on screens when an inputted voice command is not matched with any one of command databases related to content being executed on the screen.

FIG. 15 shows an exemplary user interface when there is no command database matched with an inputted voice input.

Referring to FIG. 15, the controller 180 may provide the display unit 151 with first content C3 (e.g., a game program) and second content C2 (e.g., a navigation program).

A voice command “Next Channel” spoken by a speaker is not matched with any one of a map-related command DB 161b and a game-related command DB 161d. Accordingly, the controller 180 can inform that there is no channel to be provided and provide an interface 13, querying whether input will be performed again, to the display unit 151.

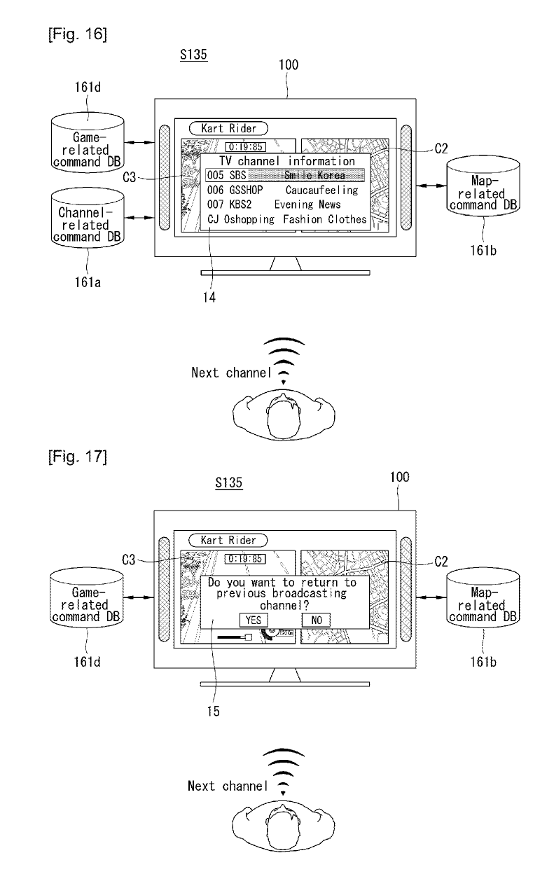

FIG. 16 shows another exemplary user interface when a command database matched with inputted voice input does not exist.

Referring to FIG. 16, the controller 180 may provide first content C3 (e.g., a game program) and second content C2 (e.g., a navigation program) to the display unit 151.

A voice command “Next Channel” spoken by a speaker is not matched with any one of a map-related command DB 161b and a game-related command DB 161d, but the controller 180 may associate the channel-related voice command with a channel-related command DB 161a stored in the electronic device 100. Accordingly, the controller 180 may provide an interface 14, indicating channel information related to a broadcasting program, to the display unit 151.

When specific channel information is selected by the speaker, the controller 180 can display a program screen, corresponding to the selected channel, in the display unit 151.

FIG. 17 shows yet another exemplary user interface when a command database matched with inputted voice input does not exist.

Referring to FIG. 17, the controller 180 may provide first content C3 (e.g., a game program) and second content C2 (e.g., a navigation program) to the display unit 151. A voice command “Next Channel” spoken by a speaker is not matched with any one of a map-related command DB 161b and a game-related command DB 161d, but the controller 180 may associate the channel-related voice command with a broadcasting program which had been executed before the game program and the navigation program were executed. Accordingly, the controller 180 may display a user interface 15, querying whether to switch the screen of the electronic device 100 to a previous watching program, in the display unit 151.

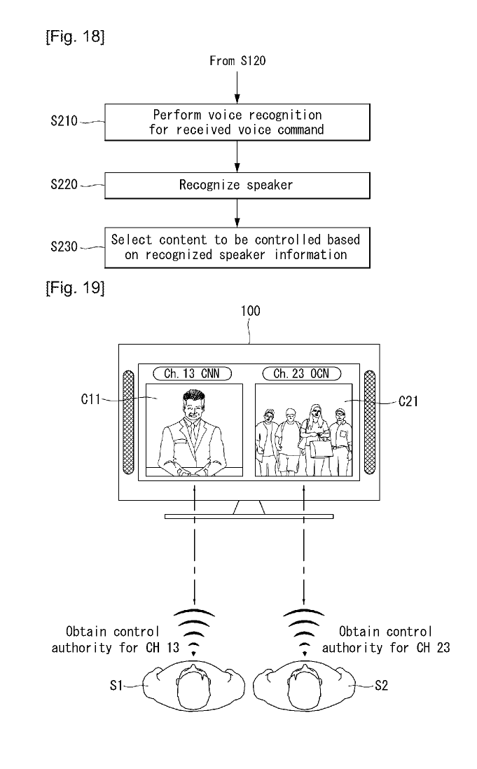

FIG. 18 is a flowchart illustrating a method of controlling the electronic device according to yet another embodiment of the present invention. FIGS. 19 to 22 show examples in which a plurality of pieces of content is controlled in response to a voice command in the embodiment of FIG. 18. The method can be executed under the control of the controller 180.

Referring to FIG. 18, when a specific voice command is received from a speaker at step S120, the voice recognition unit 182 performs voice recognition for the received voice command. The controller 180 recognizes a speaker based on the voice recognition result at step S220.

The controller 180 can select content to be controlled on the basis of the recognized speaker information at step S230.

The speaker information may include information about content whose control authority belongs to the speaker.

For example, it is assumed that first content (e.g., a broadcasting program) and second content (e.g., a navigation program) are simultaneously executed in the display unit 151, a first speaker has the control authority for the broadcasting program, and a second speaker has the control authority for the navigation program. In this case, in response to a voice command spoken by the first speaker in order to change a channel, the controller 180 can control the broadcasting program. Furthermore, in response to a voice command spoken by the second speaker in order to enlarge a map, the controller 180 may control the navigation program.

Meanwhile, the first content and the second content may be a plurality of pieces of subcontent belonging to the same content. For example, both the first content and the second content may be broadcasting programs, but the first content and the second content have a plurality of pieces of subcontent having different pieces of channel information. This is described in more detail with reference to FIG. 19.

Referring to FIG. 19, the controller 180 can display first content C11 and second content C12 in the display unit 151. Both the first content C11 and the second content C12 are broadcasting programs, but are different in channel information.

Referring to FIG. 19, it is assumed that a first speaker S1 has the control authority for “CH 13 CNN” and a second speaker S2 has the control authority for “CH 23 OCN”. The control authority for specific content that may be owned by a speaker may be previously set.

Referring to FIG. 20, when the first speaker S1 speaks a voice command “Next Channel” in FIG. 19, the controller 180 may check that the first speaker S1 has the control authority for the “CH 13 CNN” and then change the CH 13 to the “CH 14 ESPN”. At this time, the voice command spoken by the first speaker S1 is not applied to the “CH 23 OCN” program.

The same principle is applied to a voice command spoken by the second speaker S2.

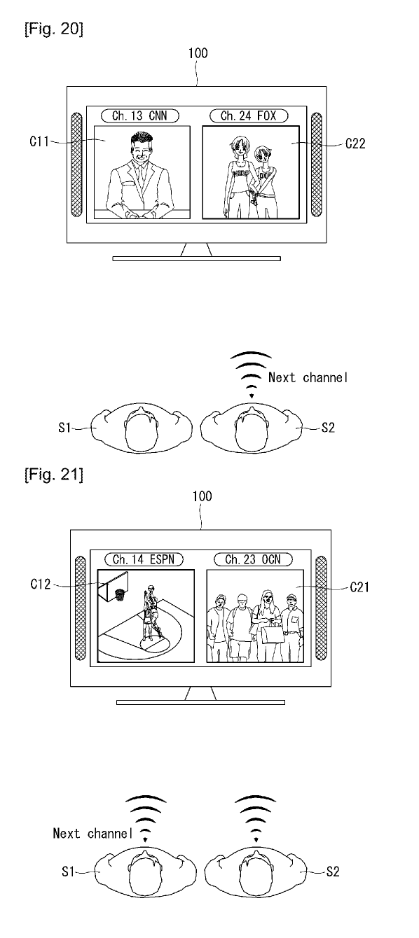

Referring to FIG. 21, when the second speaker S2 speaks a voice command “Next Channel” in FIG. 19, the controller 180 may check that the second speaker S2 has the control authority for the “CH 23 OCN” and then change the CH 23 to “CH 24 FOX”. At this time, a voice command spoken by the second speaker S2 is not applied to the “CH 13 CNN” program.

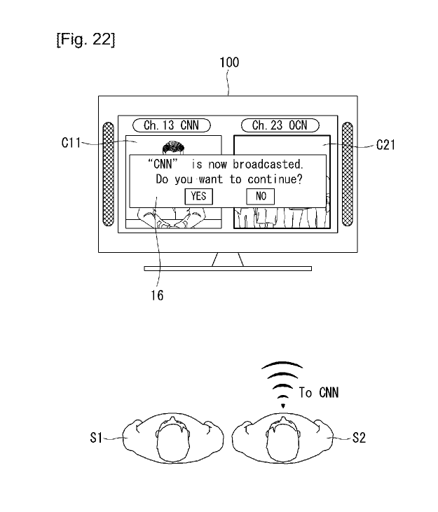

Referring to FIG. 22, when the second speaker S2 speaks a voice command “To CNN”, the controller 180 may provide a user interface 16, informing that “CNN” controlled by the first speaker S1 is now being broadcasted through the display unit 151 of the electronic device 100, the display unit 151. When the second speaker S2 selects to change the CH 23 OCN to CH 13 CNN, the controller 180 may perform control so that the “CH 13 CNN” is displayed and broadcasted in the entire region of the display unit 151.

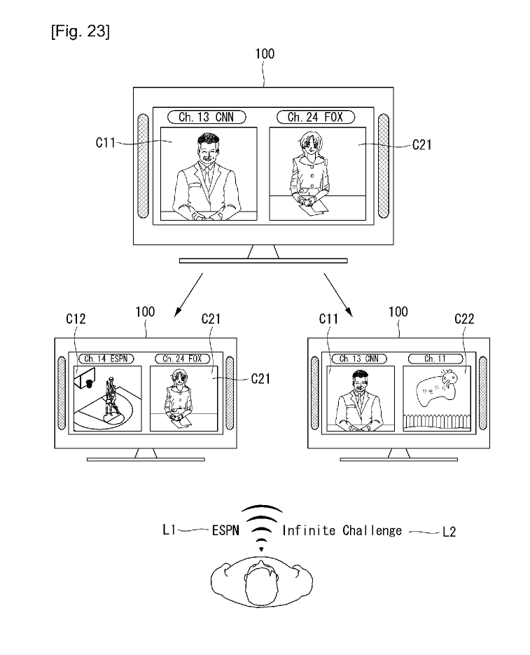

FIG. 23 is an exemplary diagram illustrating a method of controlling the electronic device according to further yet another embodiment of the present invention.

Referring to FIG. 23, the controller 180 may provide a plurality of pieces of content, being executed in different language characteristics, to the display unit 180.

For example, assuming that first content (e.g., CH 13 CNN) and second content (e.g., CH 9 KBC news) are being executed, the language characteristic of the first content may be a first language (e.g., English) and the language characteristic of the second content may be a second language (e.g., Korean).

When a speaker speaks a voice command in the first language (English), the controller 180 may apply the voice command to the first content corresponding to the first language (English). Furthermore, when a speaker speaks a voice command in the second language (Korean), the controller 180 may apply the voice command to the second content corresponding to the second language (Korean).

Referring to FIG. 23, when a speaker speaks a voice command to change a current channel to “CH 13 ESPN” in English (L1), the controller 180 does not apply the voice command to the second content (i.e., CH 9 KBC news), but to the first content (i.e., CH 13 CNN). This is true when a speaker speaks a voice command in Korean (L2) (ex, Infinite Challenge).

The information about the plurality of pieces of content disclosed in FIG. 23 describes broadcasting programs having the same attribute, but the present invention is not limited thereto. For example, the present invention may be applied to a plurality of pieces of content having different attributes.

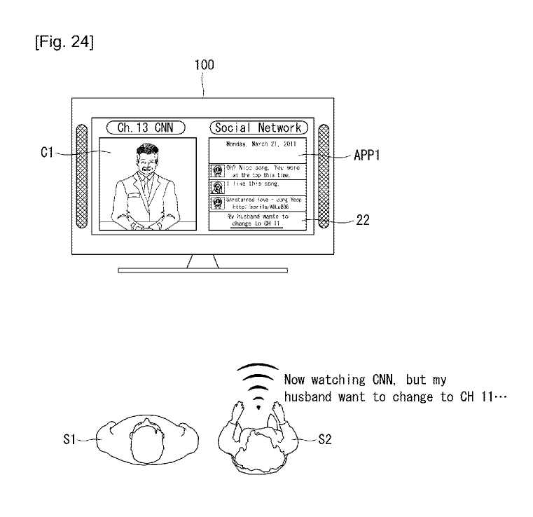

FIG. 24 is an exemplary diagram illustrating a method of controlling the electronic device according to still yet another embodiment of the present invention.

Referring to FIG. 24, the controller 180 may provide a plurality of pieces of content with different attributes to the display unit 151.

For example, first content (e.g., CH 13 CNN) and second content (e.g., Social Network Application: Appl) have different attributes. That is, a voice command for controlling the first content and a voice command for controlling the second content may have different attributes.

In this case, a voice command spoken by a second speaker S2 who is executing the second content converts the voice command signal into text which is displayed in the display unit 151. Accordingly, the voice command signal generated by the second speaker S2 is not applied to a voice command for controlling the first content.

In accordance with the electronic device and the method of controlling the electronic device according to some embodiments of the present invention, multi-tasking performed in an electronic device can be efficiently controlled through a voice command.

The method for controlling of the electronic device according to embodiments of the present invention may be recorded in a computer-readable recording medium as a program to be executed in the computer and provided. Further, the method for controlling the electronic device and the method for displaying an image of the electronic device according to embodiments of the present invention may be executed by software. When executed by software, the elements of the embodiments of the present invention are code segments executing a required operation. The program or the code segments may be stored in a processor-readable medium or may be transmitted by a data signal coupled with a carrier in a transmission medium or a communication network.

The computer-readable recording medium includes any kind of recording device storing data that can be read by a computer system. The computer-readable recording device includes a ROM, a RAM, a CD-ROM, a DVD±ROM, a DVD-RAM, a magnetic tape, a floppy disk, a hard disk, an optical data storage device, and the like. Also, codes which are distributed in computer devices connected by a network and can be read by a computer in a distributed manner are stored and executed in the computer-readable recording medium.

As the present invention may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An electronic device, comprising
a display unit;
a voice input unit; and
a control unit configured to output a plurality of contents through the electronic device, receive a voice command through the voice input unit for performing a command, determine which of the plurality of contents correspond to the received voice command, and perform the command on one or more of the plurality of contents that correspond to the received voice command.

2. The electronic device as claimed in claim 1, further comprising a plurality of command databases that each include one or more commands, wherein at least one command database corresponds to at least one of the plurality of contents, and
the control unit is configured to recognize the received voice command and, when the recognized voice command is matched with any one of the commands in the plurality of command databases corresponding to the at least one of the plurality of contents, control the at least one of the plurality of contents corresponding to the matched command database.

3. The electronic device as claimed in claim 2, wherein when the recognized voice command corresponds to more than one of the plurality of contents, the control unit is configured to control one or more of the plurality of contents, selected according to a predetermined criterion, in response to the recognized voice command.

4. The electronic device as claimed in claim 3, wherein the control unit is configured to provide a user interface for selecting content to be controlled from the plurality of contents in response to the recognized voice command.

5. The electronic device as claimed in claim 3, wherein the control unit is configured to apply the recognized voice command to each of the plurality of contents by taking a sequence that the plurality of contents is executed into consideration.

6. The electronic device as claimed in claim 3, wherein the control unit is configured to apply the recognized voice command to each of the plurality of contents by taking an arrangement of the plurality of contents output through the electronic device into consideration.

7. The electronic device as claimed in claim 3, further comprising a camera for photographing a speaker,
wherein the control unit is configured to control content toward which the speaker is directed in response to the recognized voice command.

8. The electronic device as claimed in claim wherein the control unit is configured to recognize a speaker based on the received voice command, select content to be controlled based on information about the recognized speaker, and control the selected content in response to the voice command.

9. The electronic device as claimed in claim 8, wherein the information about the recognized speaker comprises information about the speaker and content whose control authority belongs to the speaker.

10. The electronic device as claimed in claim wherein:
the plurality of contents output through the electronic device has different language characteristics, and
the control unit is configured to select content related to a language characteristic of the received voice command from the plurality of contents and control the selected content in response to the voice command.

11. The electronic device as claimed in claim wherein the voice input unit is a wired or wireless device, including one of a mobile terminal, a smart phone, a game device, a remote control, a microphone installed inside the display device, and a microphone array.

12. The electronic device as claimed in claim 1, wherein the plurality of contents comprises at least one of a broadcasting program, text, an image, sound, video, and an application executable on the electronic device.

14. A method of controlling an electronic device, comprising:
outputting a plurality of contents though the electronic device;
receiving a voice command through a voice input unit for performing a command;
determining which of the plurality of contents correspond to the voice command; and
performing the command on one or more of the plurality of contents that correspond to the received voice command.

15. The method as claimed in claim 14, wherein determining which of the plurality of contents correspond to the voice command comprises:
performing voice recognition for the received voice command; and
selecting content corresponding to a database including the recognized voice command, from among a plurality of command databases, wherein at least one command database corresponds to at least one of the plurality of contents.

16. The method as claimed in claim 14, wherein determining which of the plurality of contents correspond to the voice command comprises:
performing voice recognition for the received voice command;
recognizing a speaker based on the received voice command; and
selecting content to be controlled based on information about the recognized speaker.

17. The method as claimed in claim 14, wherein the voice input unit is a wired or wireless device, including one of a mobile terminal, a smart phone, a game device, a remote control, a microphone installed inside the display device, and a microphone array.
